(19) United States
(12) Patent Application Publication
(10) Pub. No.: US 2012/0066073 A1
(43) Pub. Date: Mar. 15, 2012

(54) USER INTEREST ANALYSIS SYSTEMS AND METHODS

(75) Inventors: Venkatachari Dilip, Cupertino, CA (US); Arjun Jayaram, Fremont, CA (US); Michael L. Palmer, Corrales, NM (US); Vivek Sehgal, Mountain View, CA (US)

(73) Assignee: Compass Labs, Inc., San Jose, CA (US)

(21) Appl. No.: 13/225,126

(22) Filed: Sep. 2, 2011

Related U.S. Application Data
(60) Provisional application No. 61/379,530, filed on Sep. 2, 2010.

(51) Int. Cl. G06Q 30/02; G06F 15/16

(52) U.S. Cl. 705/14.66; 709/204

(57) ABSTRACT

A method and system analyze user interests. In some embodiments, the method identifies online social content associated with multiple users, and identifies a portion of the online social content associated with a first user. The method determines a first user interest based on the portion of the online social content associated with the first user.

### RELATED APPLICATION

This application claims the priority benefit of U.S. Provisional Application Ser. No. 61/379,530, entitled “USER INTEREST ANALYSIS SYSTEMS AND METHODS”, filed Sep. 2, 2010, the disclosure of which is incorporated herein by reference in its entirety.

### TECHNICAL FIELD

The present disclosure generally relates to data processing techniques and, more specifically, to systems and methods for analyzing user interest.

### BACKGROUND

Interaction among users through online systems and services, such as social media sites, blogs, microblogs, and the like, is increasing at a rapid rate. These online systems and services provide different forms of content and allow users to share various types of information. The information shared by users may become content available to other users through one or more online systems. The content may include, for example, opinions, ideas, questions, answers, activity updates, favorite products/services, favorite social media sites, and the like. The content may also include user experiences and user evaluations of a product or service. For example, a user can express a favorable interest by “liking” a social media site or associating with another user as a “friend”.

### BRIEF DESCRIPTION OF THE DRAWINGS

Some embodiments are illustrated by way of example and not limitation in the figures of the accompanying drawings.

FIG. 1 is a block diagram illustrating an example environment used to implement the systems and methods discussed herein.

FIG. 2 is a block diagram illustrating example sources of information providing data used to perform user interest analysis.

FIG. 3 is a flow diagram illustrating an embodiment of a procedure for identifying user interests and selecting advertisements.

FIG. 4 is a flow diagram illustrating an embodiment of a procedure for identifying and displaying a user's interests and related information.

FIG. 5 illustrates an example display of user interests and related information.

FIG. 6 illustrates an example graphical representation of a user's interests.

FIG. 7 illustrates an example graphical representation of times during which a user is commonly active online.

FIG. 8 is a flow diagram illustrating an embodiment of a procedure for extracting topics from various data sources.

FIG. 9 is a flow diagram illustrating an embodiment of a procedure for identifying topic similarity and performing entity extraction.

FIG. 10 illustrates example relationships between various topics.

FIG. 11 is a block diagram illustrating various components of a topic extraction and analysis module.

FIG. 12 is a block diagram illustrating various components of a user interest analyzer.

FIG. 13 is a block diagram illustrating various components of an advertisement selection module.

FIG. 14 is a block diagram of a machine in the example form of a computer system within which a set of instructions, for causing the machine to perform any one or more of the methodologies discussed herein, may be executed.

### DETAILED DESCRIPTION

Example systems and methods to analyze user interests are described. In the following description, for purposes of explanation, numerous specific details are set forth in order to provide a thorough understanding of example embodiments. It will be evident, however, to one skilled in the art that the present invention may be practiced without these specific details.

The systems and methods described herein analyze interests associated with an online user based on a variety of online communications, online relationships, and other information. In a particular embodiment, the described systems and methods identify various online content (e.g., social media content) associated with any number of users. Based on at least a portion of the online content, the systems and methods determine a user interest as well as an interest score associated with various topics. Using this interest score, an advertisement is selected for presentation to the user. Thus, the advertisement is targeted to the user based on one or more likely interests of the user.

Particular examples discussed herein refer to user communications and/or user interactions via social media web sites/services, microblogging sites/services, blog posts, and other communication systems. Although these examples mention “social media interaction” and “social media communication”, these examples are provided for purposes of illustration. The systems and methods described herein can be applied to any type of content or activity for any purpose.

Additionally, certain examples described herein discuss the selection of an advertisement based on a particular user interest or other user information. In other embodiments, other types of information (in addition to an advertisement or instead of an advertisement) are selected and displayed to the user. Other types of information include, for example, recommendations or referrals to other sources of information that may be of interest to the user. A selected advertisement may be displayed to the user immediately or at a future time. In some situations, information regarding the selected advertisement is stored for future reference.

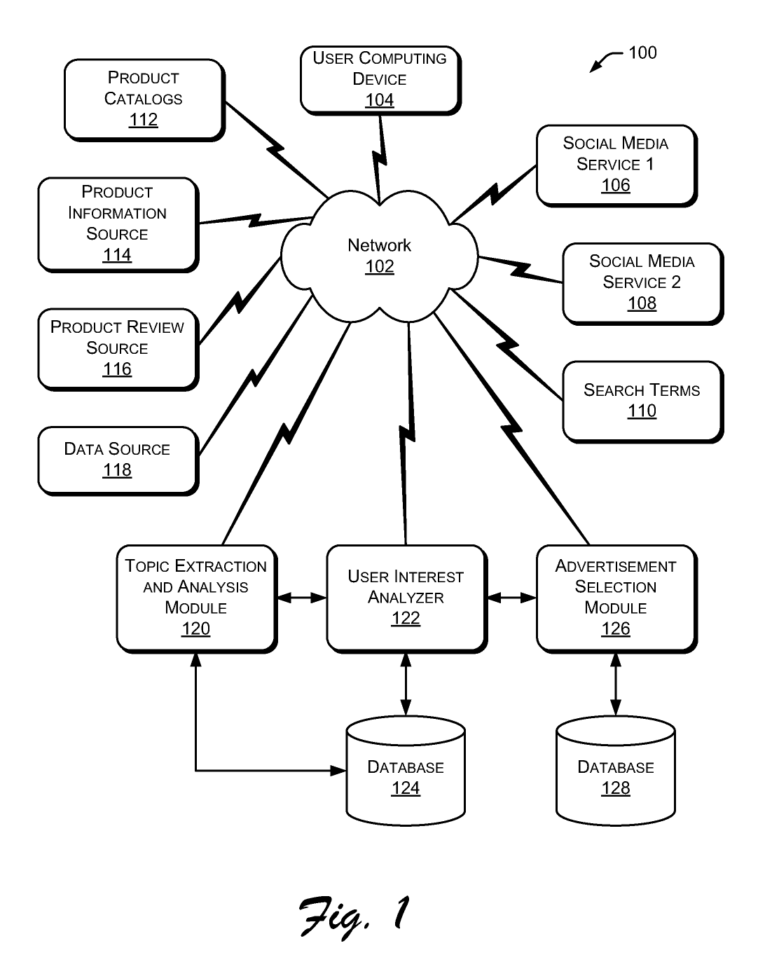

FIG. 1 is a block diagram illustrating an example environment 100 used to implement the systems and methods discussed herein. A data communication network 102, such as the Internet, communicates data among a variety of internet-based devices, web servers, data sources, and so forth. Data communication network 102 may be a combination of two or more networks communicating data using various communication protocols and any communication medium.

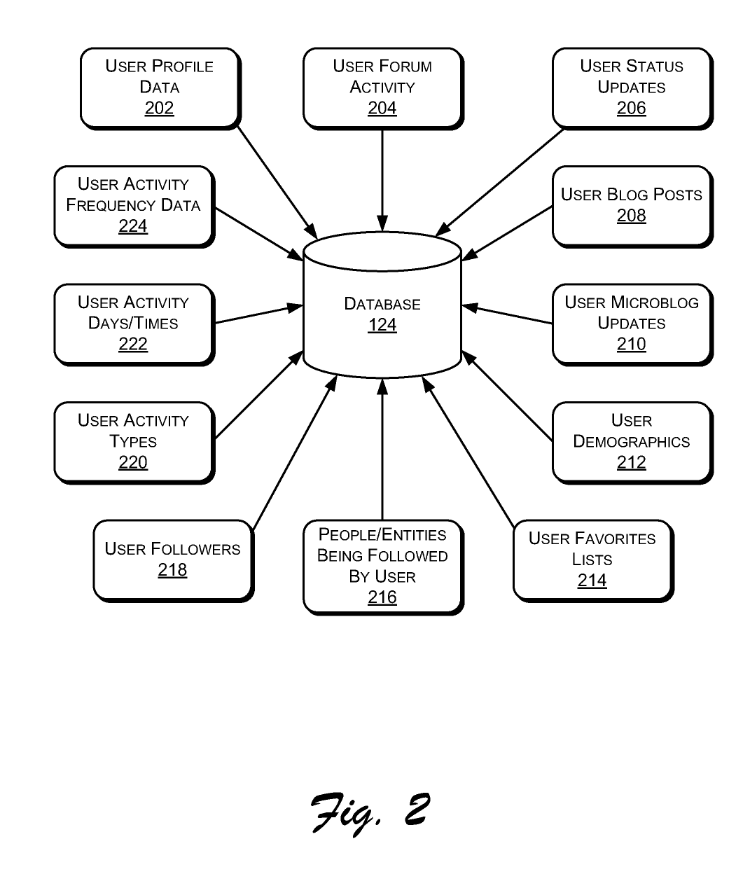

The embodiment of FIG. 1 includes a user computing device 104, social media services 106 and 108, one or more search terms (and related web browser applications/systems) 110, one or more product catalogs 112, a product information source 114, a product review source 116, and a data source 118. Additional details regarding sources of data used herein are discussed below with respect to FIG. 2. Environment 100 also includes a topic extraction and analysis module 120, a user interest analyzer 122, an advertisement selection module 126, and two databases 124 and 128. Database 124 is accessible by user interest analyzer 122 and topic extraction and analysis module 120. Database 128 is accessible by advertisement selection module 126. Although topic extraction and analysis module 120, user interest analyzer 122, and advertisement selection module 126 are shown in FIG. 1 as separate components or separate devices, in particular implementations any two or more of these components can be combined into a single device or system.

User computing device 104 is any computing device capable of communicating with network 102. Examples of user computing device 104 include a desktop or laptop computer, handheld computer, tablet computer, cellular phone, smart phone, personal digital assistant (PDA), portable gaming device, set top box, and the like. Social media services 106 and 108 include any service that provides or supports social interaction and/or communication among multiple users. Example social media services include Facebook, Twitter (and other microblogging web sites and services), MySpace, message systems, online discussion forums, and so forth. Search terms 110 include various search queries (e.g., words and phrases) entered by users into a search engine, web browser application, or other system to search for content (e.g., web-based content) via network 102.

Product catalogs 112 and other structured data sources contain information associated with a variety of products and/or services. In a particular implementation, each product catalog is associated with a particular industry or category of products/services. Product catalogs 112 may be generated by any entity or service. In a particular embodiment, the systems and methods described herein collect data from a variety of data sources, web sites, social media sites, and so forth, and “normalize” or otherwise arrange the data into a standard format that is later used by other procedures discussed herein. These product catalogs 112 contain information such as product category, product name, manufacturer name, model number, features, specifications, product reviews, product evaluations, user comments, price, price category, warranty, and the like. Other sources maintain and display a graph-like structure that shows the relation between a team, its players, location, stadiums, coaches, and so forth. The information contained in product catalogs 112 is useful in determining user interests associated with various users, and identifying one or more appropriate advertisements for the user. Although product catalogs 112 are shown as a separate component or system in FIG. 1, in alternate embodiments, product catalogs 112 are incorporated into another system or component, such as database 124, topic extraction and analysis module 120, or user interest analyzer 122, discussed below.

Another source of social media content includes check-in data in which users indicate their current location (e.g., geographic location). This check-in data provides user interest data associated with places (e.g., businesses) that a particular user visits regularly. For example, check-in messages associated with a fitness center or an organic food market provide information about the user's interests.

Product information source 114 is any web site or other source of product information accessible via network 102. Product information sources 114 include manufacturer web sites, magazine web sites, news-related web sites, TV shows, and the like. Product review source 116 includes web sites and other sources of product (or service) reviews, such as Epinions and other web sites that provide product-specific reviews, industry-specific reviews, and product category-specific reviews.

Data source 118 is any other data source that provides any type of information related to one or more products, services, manufacturers, evaluations, reviews, surveys, and so forth. Although FIG. 1 displays specific services and data sources, a particular environment 100 may include any number of social media services 106 and 108, search terms 110 (and search term generation applications/services), product information sources 114, product review sources 116, and data sources 118. Additionally, specific implementations of environment 100 may include any number of user computing devices 104 accessing these services and data sources via network 102.

Topic extraction and analysis module 120 analyzes various communications (and other content) from multiple sources and identifies key topics within those communications. Example communications include user posts on social media sites, microblog entries (e.g., “tweets” sent via Twitter) generated by users, product reviews posted to web sites, friend requests, online group associations, “liked” sites or web pages, and so forth. Topic extraction and analysis module 120 may also actively “crawl” various web sites and other sources of data to identify content that is useful in determining a user interest and/or an advertisement associated with a user's interests. User interest analyzer 122 determines various interests and topics associated with the user communications and other content. Advertisement selection module 126 selects one or more advertisements for a particular user based on that user's interests, interest score, and so forth, as discussed herein.

Database 124 stores various user interest information, communication information, content, topic information, intent information, response data, and other information generated by and/or used by user interest analyzer 122 and topic extraction and analysis module 120. Database 128 stores various information related to advertisements and other data used by advertisement selection module 126. Additional information regarding topic extraction and analysis module 120, user interest analyzer 122 and advertisement selection module 126 is provided herein.

FIG. 2 is a block diagram illustrating example sources of information providing data used to perform user interest analysis. The user data from multiple sources is collected and stored in database 124. The data may be collected and/or processed by any number of devices prior to being stored in database 124. For example, the data can be processed by user intent analyzer 122 or topic extraction and analysis module 120 prior to storage in database 124.

As shown in FIG. 2, received data includes user profile data 202 received from one or more sources, such as online data sources, social media web sites, and so forth. Additional data regarding user interests and user activities is received from online forums 204 in which users post comments, view information and monitor various discussions. Additional user information is obtained from user status updates 206, such as social media communications and other online communications. User blog posts 208 and user microblog updates 210 also provide information regarding a user's interests and activities. User demographics 212 are useful in identifying information about the user and predicting interests, activity levels, and the like.

Information about users is also received from user favorites lists 214, such as lists of favorite web sites, favorite online discussions, group subscriptions in online social media forums, subscriptions to various email lists and other information sources, and the like. Data about users is also obtained based on the people, groups, or entities being followed by the user 216, such as the people, groups, or entities being followed through various online social media services. Additionally, user information is obtained regarding the people, groups, or entities following the user 218. These followers tend to show topics with which the user has significant experience or knowledge.

FIG. 2 also shows that additional data received about a user includes user activity types 220 and user activity days/times 222. User activity types 220 include the most common types of communications, such as blog posts, re-posting of information, social media communications, and so forth. User activity days/times 222 identifies the days and times during which the user is most active in online activities, such as online social interactions, reading online information, posting online information, and the like. User activity frequency data 224 includes information regarding how often a particular user accesses a specific online service, generates an online social communication, the frequency with which a user performs an activity associated with a particular topic, and so forth. The information received from the sources shown in FIG. 2 is received from multiple sources over a period of time. In a particular embodiment, this receiving of information continues on a regular basis, such that the information stored in database 124 is updated on a continual basis.

In particular embodiments, the systems and methods described herein identify online social content associated with multiple users. The online social content can be associated with any number of different web sites, social media services, and the like. A portion of the online social content is associated with a particular user (e.g., specific blog posts, social media interactions, liked content, friend/follow relationships, and product/service reviews generated by the particular user). The systems and methods identify the portion of the online social content associated with the particular user and determine one or more interests of the particular user based on that portion of the online social content. These interests are used to identify other interests, identify advertisements, and identify other information that may be of interest to the particular user.

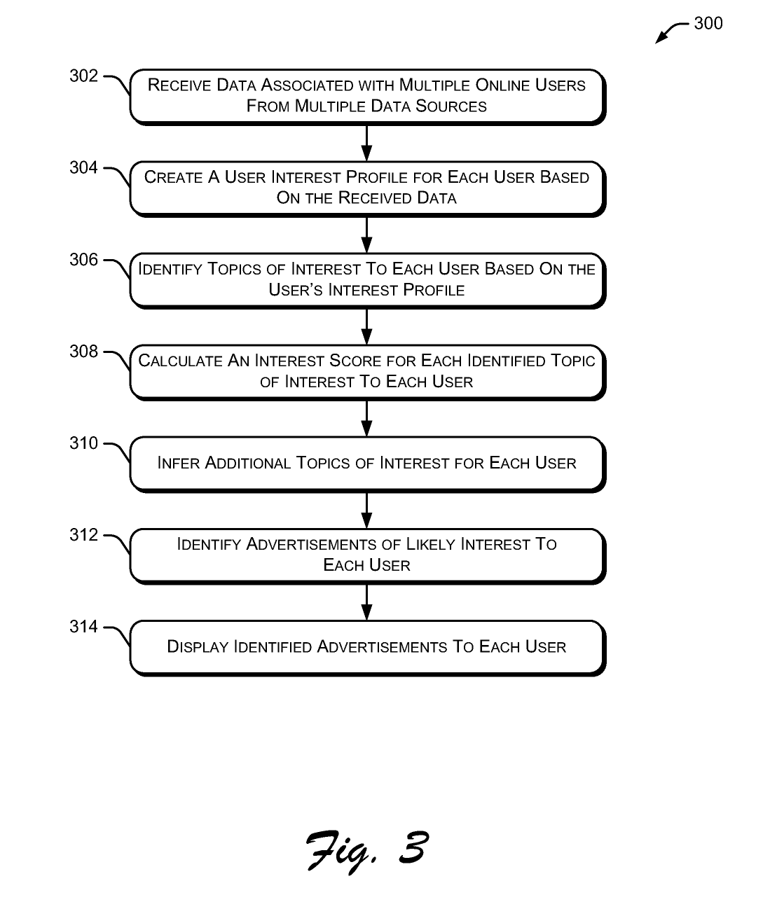

FIG. 3 is a flow diagram illustrating an embodiment of a procedure 300 for identifying user interests and selecting advertisements. Initially, procedure 300 receives data associated with multiple online users from multiple data sources (block 302), such as one or more of the data sources discussed above with respect to FIG. 2. The procedure continues by creating a user interest profile for each user based on the received data (block 304). As discussed herein, this user interest profile includes, for example, information regarding topics of interest to the user, their degree of interest in each topic, the user's level of expertise for each topic, their level of interaction (e.g., activity level) for each topic, and times when the user is typically active online.

Procedure 300 continues by identifying topics of interest to each user based on information contained in the user interest profile (block 306). For each user, an interest score is calculated for each identified topic of interest to the user (block 308). This interest score is based on a variety of factors, such as the information contained in the user interest profile and other information discussed herein. Next, the procedure infers one or more additional topics of interest for each user (block 310). These additional topics are inferred based on information contained in the user interest profile as well as known relationships between topics, as discussed herein. For example, data collected from many users may indicate that users who are interested in “designer shoes” are also interested in “designer handbags”. In this example, if a particular user's interest profile indicates an interest in “designer shoes”, the procedure infers that the particular user is also likely to be interested in “designer handbags” as well due to the collected data and topic relationships from other users. Additional details regarding the aggregation of data to determine topic relationships are provided below.

Procedure 300 continues by identifying one or more advertisements that are likely to be of interest to each user (block 312) based on their user interest profile, interest score, and similar information. Finally, the identified advertisements are displayed (or scheduled for display) to each user (block 314). Certain advertisements may be presented to particular users immediately while other advertisements may be presented at a later time based on the user's online activity levels at different times of the day or different days of the week. The advertisements may be presented to the user in a variety of forms, such as email messages, text messages, social media communications, or advertisements embedded within a web site (e.g., embedded within the user interface of a social media site) or displayed within an online application (e.g., TweetDeck and other applications that facilitate interaction with online web sites and/or social media services).

When determining user interest in a particular topic, the systems and methods described herein may refer to multiple previous conversations of a specific user. Also, the systems and methods may analyze words contained in conversations by other users regarding the topic. This analysis includes identifying particular phrases or words that indicate an interest in the topic. For example, conversations referring to “tee” or “back 9” may be associated with the topic of golf, even though the conversations may not specifically mention the word “golf”. Thus, when other users mention “tee” or “back 9” in their conversations, the systems and methods described herein may automatically associate those conversations with the topic of golf. Thus, the analysis process considers multiple conversations from any number of users to develop a set of terms and phrases associated with specific topics.

In a particular implementation, advertisement selection is determined based on who a particular user is communicating with. For example, if a user “John” usually talks about golf when communicating with “Bob” (based on analysis of multiple previous communications between John and Bob), whenever John communicates with Bob, John will be presented with an advertisement related to golf. Thus, even if the current conversation is not about golf, John is presented with a golf-related advertisement because the system knows of John's interest in golf.

When analyzing the interests of a specific user, the systems and methods also consider whether the user initiated the conversation and how actively the user engages in conversations on various topics. If a user is highly engaged with conversations related to a particular topic, that topic is given a high user interest score as compared to topics in which the user is not as active. These systems and methods are capable of extracting user interests from any type of conversation, even if the conversations have little or no sentence structure, poor grammar, and slang terms. When analyzing the interests of one or more users, the systems and methods described herein may also analyze the frequency with which the topic is mentioned throughout all social content (i.e., the popularity of the topic).

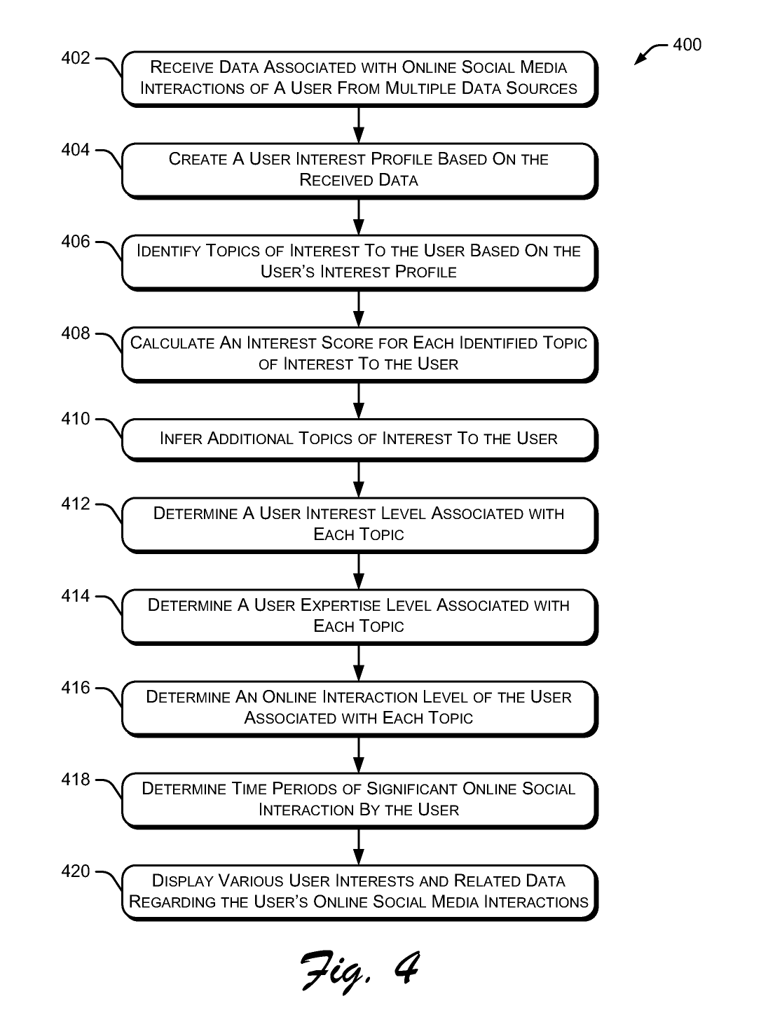

FIG. 4 is a flow diagram illustrating an embodiment of a procedure 400 for identifying and displaying a user's interests and related information. Initially, the procedure receives data associated with online social media interactions of a user from multiple online data sources (block 402). The procedure then creates a user interest profile based on the received data (block 404) and identifies topics of interest to the user based on the user interest profile (block 406). An interest score is calculated for each topic of interest to the user (block 408). Procedure 400 also infers additional topics of interest to the user (block 410) and determines a user interest level associated with each topic (block 412). Additionally, the procedure determines a user expertise level associated with each topic (block 414) and determines an online interaction level of the user associated with each topic (block 416).

When evaluating topics, the procedures described herein determine the popularity of a particular topic. The procedures also evaluate the interest level and activity level of particular users with respect to specific topics. Also, an experience level (e.g., expert status) is determined based on how many people follow a particular individual regarding a specific topic (i.e., the number of followers that seek guidance from the individual related to the specific topic). The quality of content generated by a particular individual is also evaluated when determining an expertise (or experience) level of the individual with a particular topic. For example, the procedures evaluate the quality and frequency of microblog posts and other social media content associated with the user. If the content is generalized or provides minimal value, the individual's expertise or experience level may be reduced. If content is communicated infrequently, the expertise level can be further reduced. Additionally, the procedures evaluate the quality of landing pages or other web pages that the individual directs followers to in their social media communications and other content. Determining whether someone is an “expert” in a particular topic may vary depending on the popularity of the topic. For example, if a topic is very popular with numerous social conversations, an “expert” will be more active with conversations on this popular topic than an “expert” in a topic that is less popular.

The procedure of FIG. 4 continues by determining time periods of significant online social interaction by the user (block 418). For example, a particular user may be active from 8:00-9:00 am and again from 7:00-9:00 pm. These periods of activity are useful in determining when to communicate certain targeted advertisements or other information to the user (e.g., time periods when the user is likely to be online to immediately receive those targeted advertisements or other information). Finally, procedure 400 displays various user interests and related data (block 420), such as data regarding the user's online social media interactions. This data is displayed, for example, to an administrator or other user responsible for generating or managing advertisements.

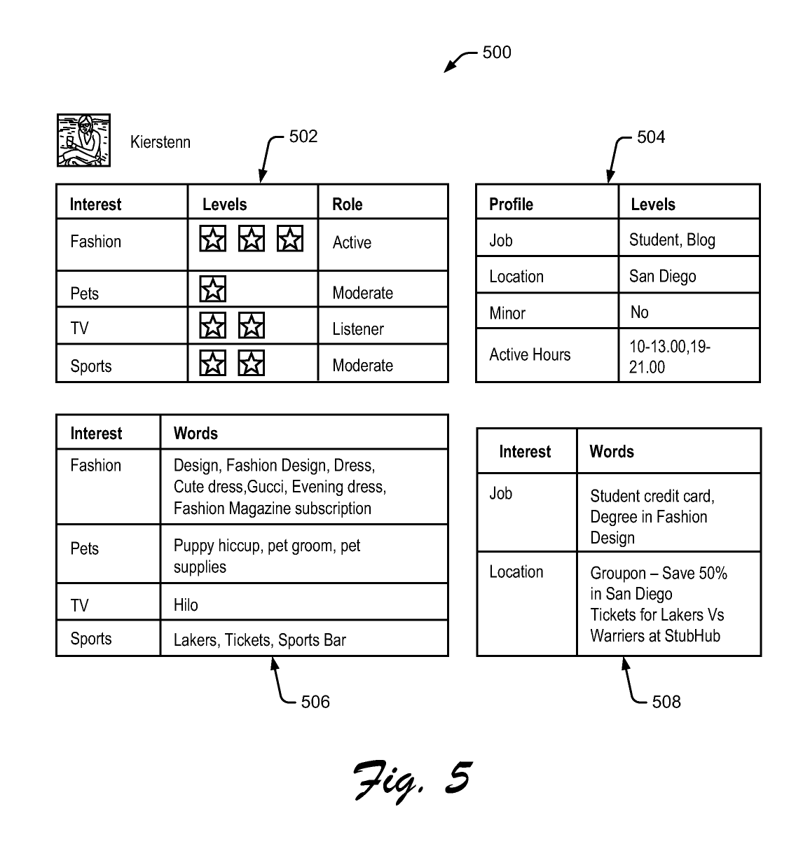

FIG. 5 illustrates an example display 500 of user interests and related information. In this example, table 502 shows that a user (Kierstenn) has interests in the topics of fashion, pets, TV and sports. Each of those four interests has an associated level (e.g., interest level) and role. The role indicates the user's activity level and/or type of activities of the user for each interest. For example, Kierstenn is active in fashion, has moderate activity regarding pets, is a listener for TV content, and has moderate activity regarding sports. An “active” role may indicate a user that provides information or regularly participates in discussions on the topic. A “listener” is a user that receives information about the topic, but does not provide as much information on the topic to other users. A “moderate” role has an activity level between “active” and “listener”.

Table 504 in FIG. 5 shows user profile information, such as the user's job type, geographic location, whether they are a minor (e.g., under age 18), and the hours during which the user is typically active online and/or with social media interactions. Table 506 shows words contained in social media interactions and other communications generated by the user. For example, regarding the “fashion” topic, Kierstenn has generated communications with the words “design”, “fashion design”, “dress”, and “cute dress”. The remaining words in the table regarding fashion (“Gucci”, “evening dress”, and “fashion magazine subscription”) are inferred by the systems and methods described herein. For example, these words may be inferred based on content from other users that contained similar words or phrases. Table 506 also shows words contained in social media content generated by (or associated with) the user regarding the topics of Pets, TV and Sports.

Based on the user's interests, the system selects one or more advertisements likely to be of interest to the user. Table 508 shown in FIG. 5 displays words contained in particular advertisement content related to “Job” and “Location”. For example “job” advertisements likely to be of interest to Kierstenn contain words such as “student credit card” and “degree in fashion design”. Similarly, example location-based advertisements likely to be of interest to Kierstenn (who lives in Southern California) contain words such as “Save 50% in San Diego” and “Tickets for Lakers vs. Warriors”.

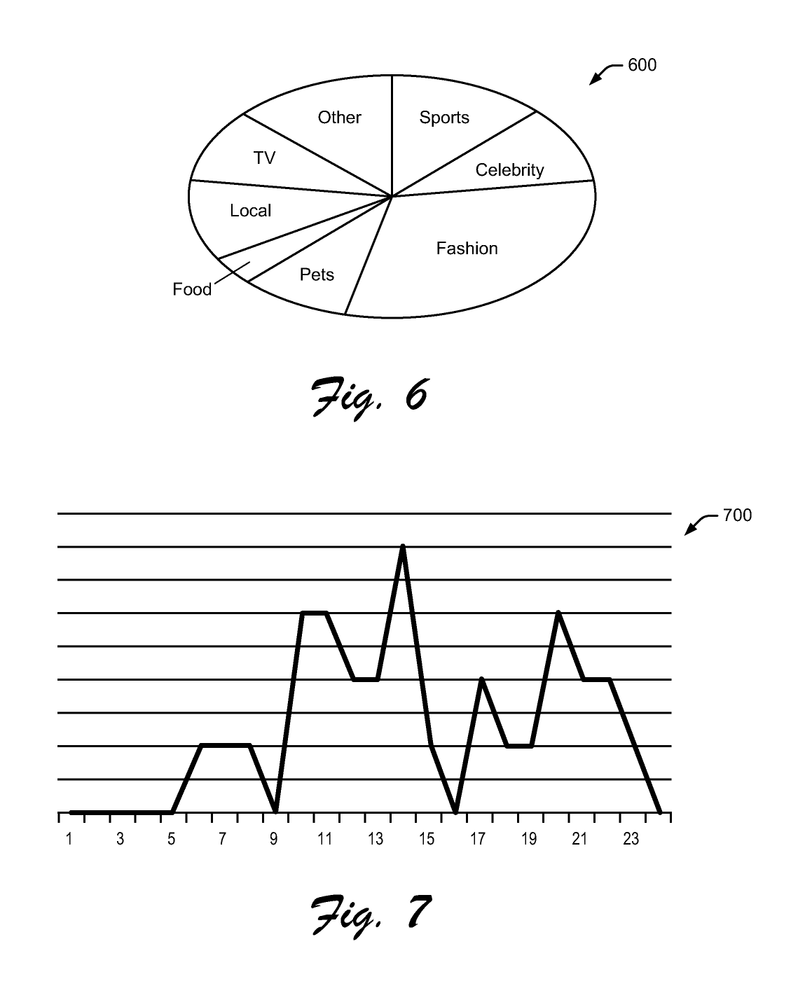

FIG. 6 illustrates an example graphical representation of a user's interests. In this example, a pie chart 600 shows the relative distribution of the user's interests among various topics (sports, celebrity, fashion, pets, food, local, TV, and other). The relative size of each portion of pie chart 600 is determined based on various factors, such as the number of online social interactions by the user for the particular topic, the topics followed by the user, the user's level of expertise regarding the topic, and the like. In this example, the topic with the greatest user interest is “fashion”. Alternate embodiments may display similar user interest information in other formats, such as tabular formats, bar graphs, and so forth.

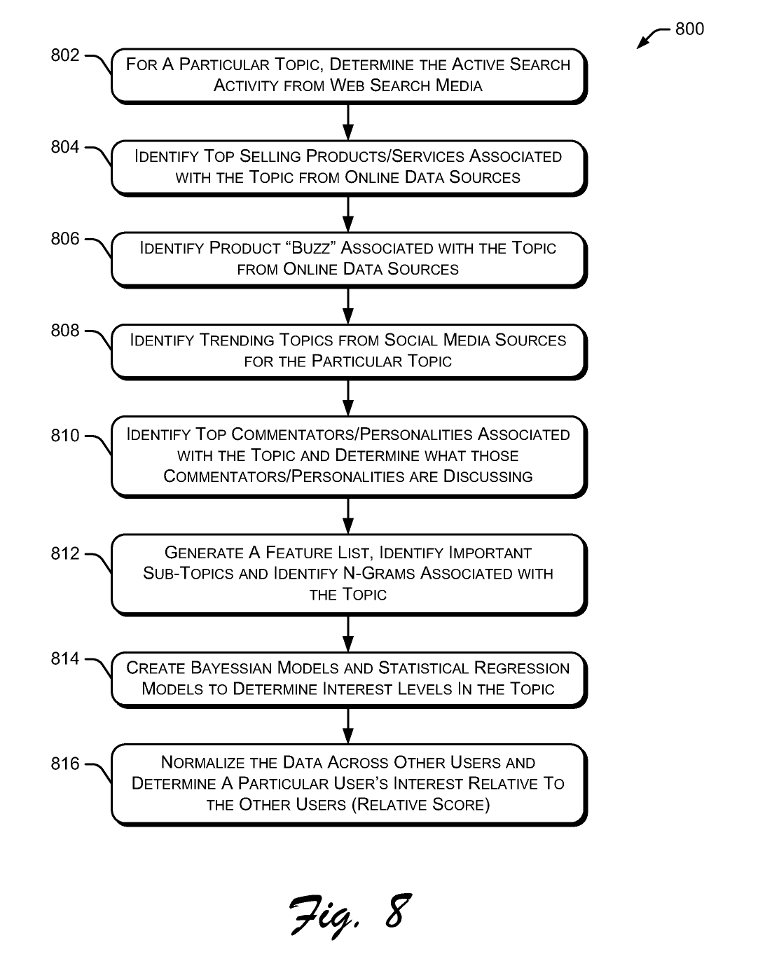

FIG. 7 illustrates an example graphical representation of times during which a user is commonly active online. In this example, a line graph 700 shows the user's online activity at different times, averaged across multiple days (or longer periods of time). The horizontal axis of line graph 700 represents the time of day, shown in a 24 hour format. The vertical axis of line graph 700 represents the volume of activity, such as the volume of microblog posts, number of web sites visited, number of social media communications, and the like. Alternate embodiments may display similar user activity information in other formats or using different time period segments, such as displaying time segments in 15 minute intervals instead of one hour intervals.

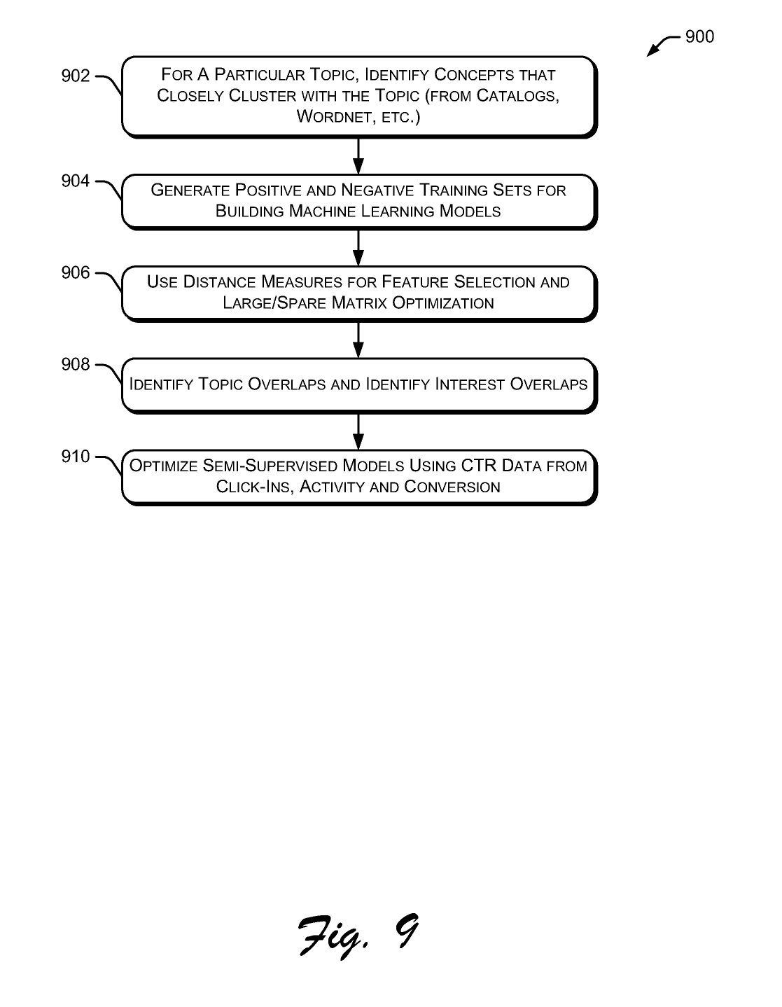

FIG. 8 is a flow diagram illustrating an embodiment of a procedure 800 for extracting topics from various data sources. For a particular topic, the procedure determines the active search activity from web search media (block 802). The procedure may also evaluate landing pages associated with microblog posts and other social media communications. If the landing page is a purely commercial site rather than a site that provides useful non-commercial information, the landing page (as well as the individual associated with the social media communications directing followers to that landing page) is provided with a lower quality score.

Procedure 800 continues by identifying top selling products and/or services associated with the particular topic (block 804). These top selling products/services are identified from one or more online data sources, such as online stores that sell products or services associated with the particular topic. The procedure also identifies product “buzz” associated with the particular topic from online data sources (block 806) and identifies trending topics from one or more social media sources for the topic (block 808). The “buzz” and trending topic information is obtained, for example, from online discussions, social media interactions, news articles, and the like. Next, the procedure identifies top commentators and/or personalities associated with the particular topic and determines what those commentators/personalities are currently discussing (block 810). The procedure then generates a feature list, identifies important sub-topics, and identifies n-grams associated with the topic (block 812). Next, the procedure creates Bayesian Models and statistical regression models to determine interest levels in the topic (block 814). Bayesian models identify a structure or relationship between different variables. Statistical regression models show relationships between different variables (e.g., topics or user interests discussed herein). Finally, procedure 800 normalizes the data across other users and determines a particular user's interest relative to the other users (block 816). A particular user's relative interest is also referred to as a “relative score”. The types of statistical models and other analysis techniques applied to a particular set of data may vary depending on the particular topic and/or topic category.

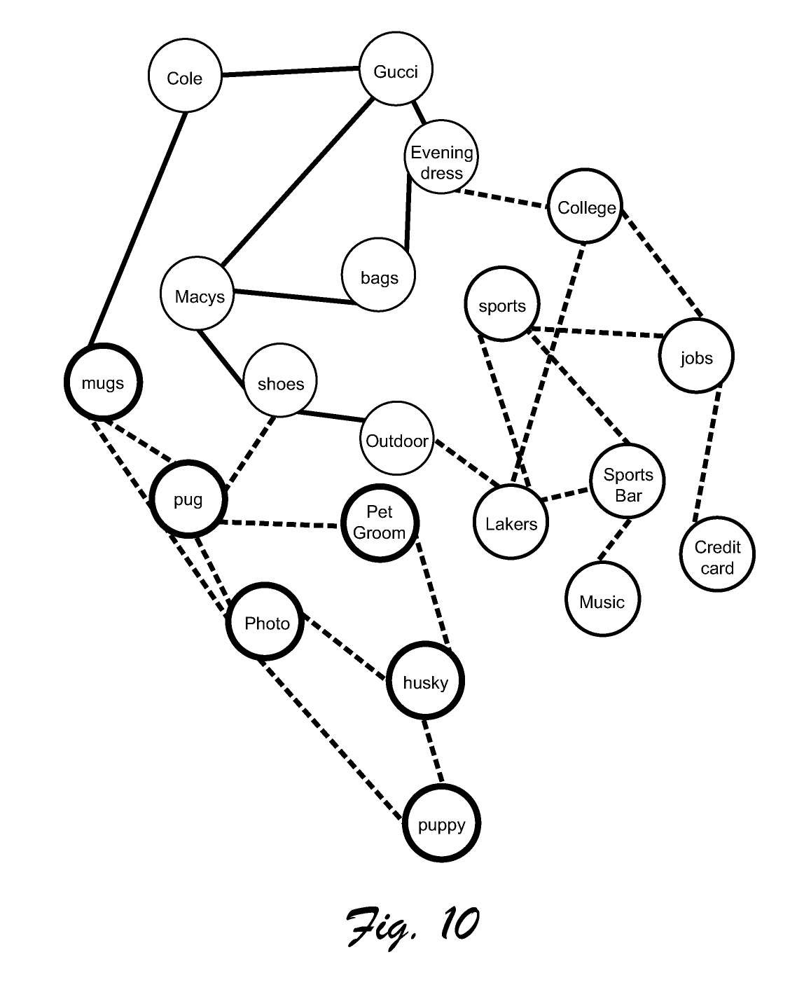

FIG. 9 is a flow diagram illustrating an embodiment of a procedure 900 for identifying topic similarity and performing entity extraction. Initially, the procedure identifies concepts that closely cluster with a particular topic (block 902). The information used to cluster various concepts is received from various sources, such as product catalogs, the WordNet lexical database, and other data sources. The procedure continues by generating positive and negative training sets for building machine learning models (block 904). Distance measures are used for feature selection and large/spare matrix optimization (block 906). Procedure 900 then identifies topic overlaps and identifies interest overlaps (block 908). Finally, the procedure optimizes semi-supervised models using CTR (click-through rate) data from click-ins, activity and conversion (block 910).

Different types of advertisements may have various associated parameters, such as how often an advertisement can be displayed and the maximum number of advertisement displays in a 24 hour period. For example, an advertising budget may be spread across multiple days and multiple time periods. Also, when selecting among multiple advertisements, the systems and methods described herein may determine which advertisement is “best” at the current time (e.g., based on the current day of the week, time of day, and the user to which the advertisement is being displayed).

In particular embodiments, a mutual information-based approach is used to identify (or extract) topics. In these embodiments, a seed set of n-grams is developed. The n-grams in the seed set are classified to a certain node in a taxonomy. One approach to representing categories is to graphically show one connection to a parent and multiple connections to the children of the parent. This approach produces a tree structure. The tree structure is collectively referred to as a taxonomy. The nodes in the tree structure represent a category or sub-category. For example, a “sports” category may include baseball, basketball, golf, tennis, and the like. The following procedure represents an example approach to identify (or extract) topics or categories.

Step 1: Generate n-grams for the appropriate nodes from a graph, such as a Freebase graph. There are several public catalogs available for specific topics that organize information, such as DBPedia for general information, MusicBrainz.com for music information, FreeDB for media information, and Freebase for various categories of information. These public catalogs include information such as names of entities (e.g., artist and album for music categories). Additionally, for a music-related example, the public catalogs may include an association between artists, their albums, the year of release, and so forth. This structured information from different sources is represented graphically where the entities form the nodes and the relation between the entities form the edges between them. In another example, for baseball and basketball, a node of the Freebase graph translates directly to baseball. For the “sports” category, multiple n-grams from multiple categories are included, such as: American football, baseball, basketball, bicycles, chess, cricket, ice hockey, martial arts, Olympics, skiing, soccer, and tennis. These multiple n-grams represent a candidate set from which the seed set of n-grams are selected.

Step 2: Based on messages and other content identified from multiple social media sites and other sources, the procedure generates Inverse Document Frequencies (IDFs) for all of the unique words and n-grams. IDFs are used in search technology to determine whether a word is “important” for classification or relevancy. The less frequent a word is across all documents, the more “rich” context it provides about the topic. For example, words such as “the”, “and”, and “for” have a high document frequency and, therefore, a low IDF. For the n-grams identified in Step 1, the procedure identifies the highest IDF score items. Items that match a particular level of IDF score cut-off are added to the seed set of n-grams. The IDF score cut-off can be different for each category and can be determined based on user input and/or testing procedures. The seed set of n-grams is then “cleaned”, by removing terms with low IDFs to improve the relevance of the remaining terms. The resulting “cleaned” seed set of n-grams typically includes several thousand n-grams for each category.

Step 3: Each n-gram in the seed set is initially marked as belonging to the category associated with the seed set. This initial association with the seed set may change later as a result of further testing or processing.

Step 4: The procedure continues by expanding the initial n-gram seed set. This expansion of the n-gram seed set includes the addition of co-occurring terms from the messages and other content identified in Step 2. This step generates a set of candidate n-grams by adding the co-occurring terms to the seed set.

Step 5: For each n-gram generated in Step 4, the procedure uses mutual information (or conditional probability) to determine whether the occurrence of a particular n-gram indicates that the message belongs in the category. Since a particular seed set typically includes thousands of n-grams for each category, the procedure can determine a probability distribution for the presence of an n-gram being able to determine the category of the message.

Step 6: The outputs generated at Step 1 and Step 5 are used to generate a final set of n-grams for the model. The presence of any of these n-grams in a message indicates that the message will be marked as belonging to the category. Additionally, an n-gram can annotate a message as belonging to different categories.

Step 7: The procedure continues by checking each n-gram against known social media interests, such as Facebook interests. If a match is identified between an n-gram and a known social media interest, the n-gram is marked as belonging to the category and becomes part of an interest cluster associated with that category.

Step 8: The procedure next identifies additional social media interests that are not yet categorized. The procedure repeats Step 5 to categorize these additional social media interests.

In other embodiments, a graph-based procedure is used to identify (or extract) topics. In these embodiments, the graph-based procedure stores all words in a message or other content as a node in a connected graph. Each node in the connected graph may have an edge connecting to another node in the graph. Typically, all nouns (both proper and common nouns) are candidates for the graph. Generation of the graph includes a seeding process in where structured data is accessed (e.g., Freebase data) to identify initial nodes of the graph for each category. An example seeding process may identify names of all football teams as well as the coaches, players, owners, and stadiums associated with the football teams. All of the identified initial nodes are labeled as belonging to the category with a high level of probability.

If a word (node 1) is connected to another word (node 2) via a connecting word, the procedure creates a bi-directional edge from node 1 to node 2 with the connecting word as the property. If a particular node is close enough to another node to be “labeled” as in the category, the particular node is considered to be predictive of the category as long as the connecting property is present. The more “hops” between a node and a category node, the less predictive the word is with respect to predicting the correct category. A “predictive score” can be pre-computed with multiple iterations of the graphs using a score relaxation measure. Using “rank induction”, a node “inducts” rank from the neighboring nodes to which it is connected. When the graph is a user's social connections (where each user has an interest score for a topic), the nodes that follow/friend the user also get a small portion of the score. For example, the raw score (R0) is the score associated with the node at the beginning (e.g., iteration 0 (I0)). During the first iteration, R0 changes by a delta (d), so the new score for the node is R0+d. When the iteration is run a second time, there is another change to the score. The iteration process continues until the overall score change between successive iterations is small, thereby indicating convergence.

The resulting graph structure is often large and complex. Each node in the graph is represented with an ID for the associated word and category. In particular embodiments, an ID index is generated and redundant copies of the ID index are maintained across multiple machines or systems.

When receiving an incoming message, the message is tokenized into a data stream. Each token is then looked up using the graph. If a particular token does not correspond to a node in the graph, the token is ignored. If the token is present in the graph, all of the outbound properties associated with the node are introspected. The procedure then determines whether any of the outbound properties are also present in the token stream. If they are present in the token stream, the token(s) are assigned the probability score associated with the category.

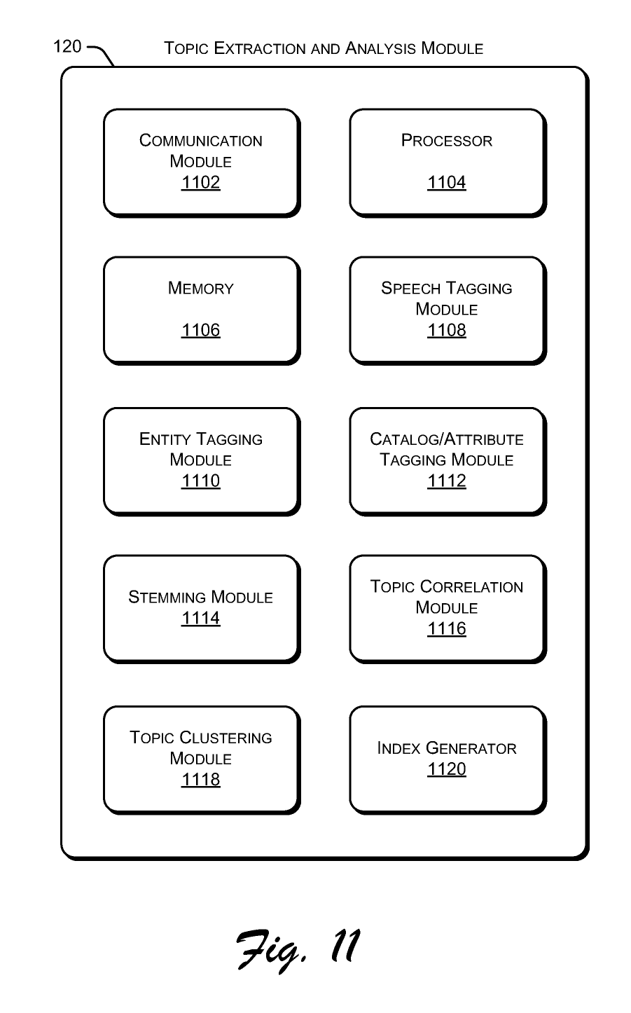

FIG. 10 illustrates example relationships between various topics. These relationships are identified based on analysis of online content as discussed herein. For example, based on analysis of multiple online conversations, when the term “Macys” occurs in a conversation, that user is also likely to be interested in “Gucci”, “bags” and “shoes”. So, if a particular user mentions “Macys” in a conversation, the additional areas of potential interest (Gucci, bags and shoes) are used to display an advertisement (or other information) related to these terms, such that the advertisement (or other information) is targeted to the user. For example, the user that mentioned “Macys” may see an advertisement for Gucci bags or an upcoming sale on shoes.

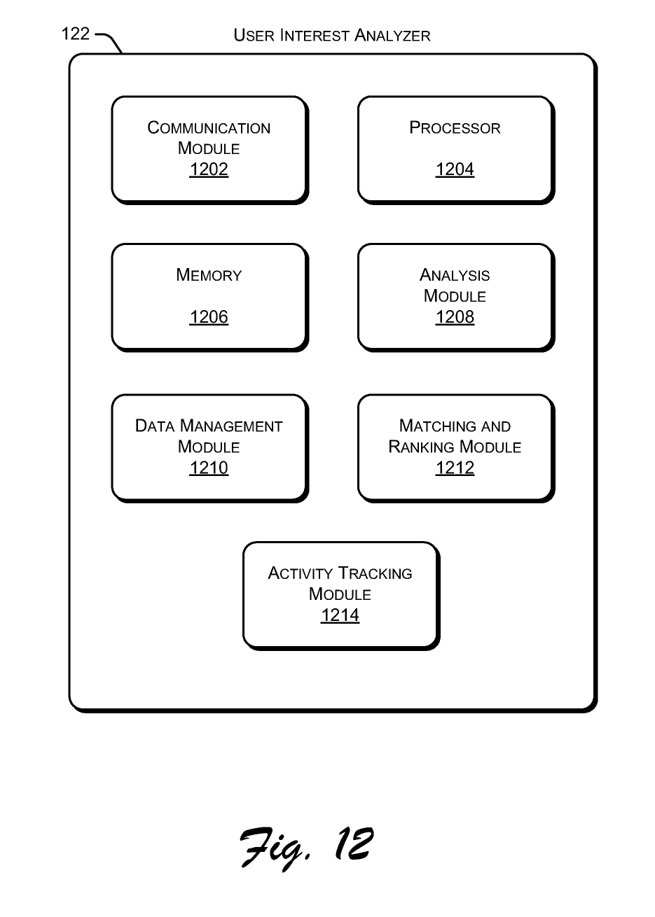

FIG. 11 is a block diagram illustrating various components of topic extraction and analysis module 120. Topic extraction and analysis module 120 includes a communication module 1102, a processor 1104, and a memory 1106. Communication module 1102 allows topic extraction and analysis module 120 to communicate with other devices and services, such as the services and information sources discussed herein. Processor 1104 executes various instructions to implement the functionality provided by topic extraction and analysis module 120. Memory 1106 stores these instructions as well as other data used by processor 1104 and other modules contained in topic extraction and analysis module 120.

Topic extraction and analysis module 120 also includes a speech tagging module 1108, which identifies (and tags) certain portions of a communication (e.g., specific words in a communication) that are used in determining a user intent associated with the communication and generating an appropriate response. Entity tagging module 1110 identifies and tags (or extracts) various entities in a communication or interaction. In the following example, a conversation includes “Deciding which camera to buy between a Canon Powershot SD1000 or a Nikon Coolpix S230”. Entity tagging module 1110 tags or extracts the following:

Extracted Entities:

Direct Products Type (extracted): Camera

Product Lines: Powershot, Coolpix

Brands: Canon, Nikon

Model Numbers: SD1000, S230

Inferred Entities:

Product Type: Digital Camera (in this example, both models are digital cameras)

Attributes: Point and Shoot (both entities share this attribute)

Prices: 200-400

In this example, the entity extraction process has an initial context of a specific domain, such as “shopping”. This initial context is determined, for example, by analyzing a catalog that contains information associated with multiple products. A catalog may contain information related to multiple industries or be specific to a particular type of product or industry, such as digital cameras, all cameras, video capture equipment, and the like. Once the initial context is determined, topics are inferred from the catalog or other information source, and the entities are tagged as “product types”, “brands”, “model numbers”, and so forth depending on how the words are used in the communication.

Catalog/attribute tagging module 1112 identifies (and tags) various information and attributes in online product catalogs, other product catalogs generated as discussed herein, and similar information sources. This information is also used in determining a user intent associated with the communication and generating an appropriate response. In a particular embodiment, the term “attribute” is associated with features, specifications or other information associated with a product or service, and the term “topic” is associated with terms or phrases associated with social media communications and interactions, as well as other user interactions or communications.

Topic extraction and analysis module 120 further includes a stemming module 1114, which analyzes specific words and phrases in a user communication to identify topics and other information contained in the user communication. A topic correlation module 1116 and a topic clustering module 1118 organize various topics to identify relationships among the topics. For example, topic correlation module 1116 correlates multiple topics or phrases that may have the same or similar meanings (e.g., “want” and “considering”). Topic clustering module 1118 identifies related topics and clusters those topics together to support the intent analysis described herein. An index generator 1120 generates an index associated with the various topics and topic clusters. Additional details regarding the operation of topic extraction and analysis module 120, and the components and modules contained within the topic extractor, are discussed herein.

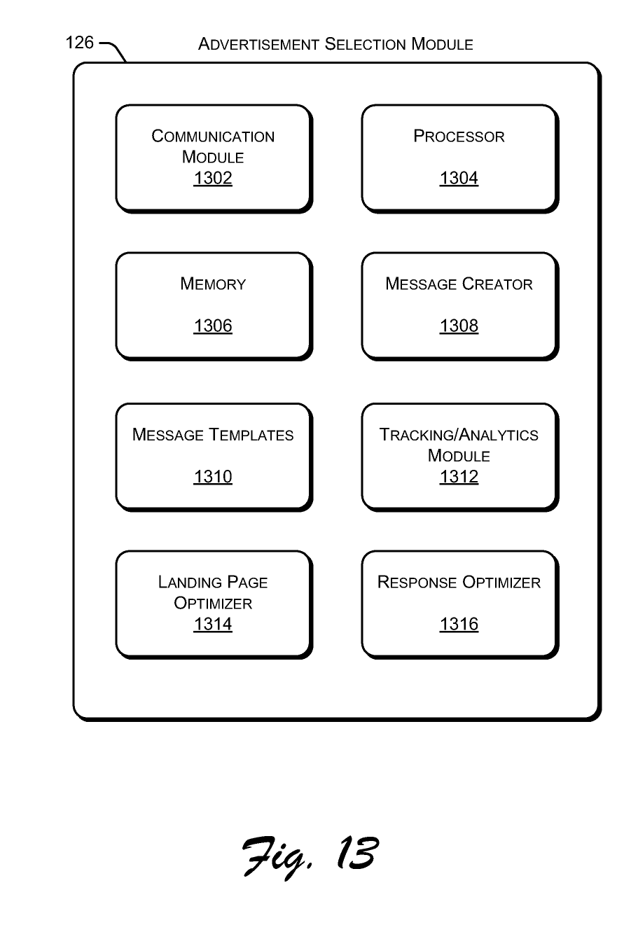

FIG. 12 is a block diagram illustrating various components of user interest analyzer 122. User interest analyzer 122 includes a communication module 1202, a processor 1204, and a memory 1206. Communication module 1202 allows user interest analyzer 122 to communicate with other devices and services, such as the services and information sources discussed herein. Processor 1204 executes various instructions to implement the functionality provided by user interest analyzer 122. Memory 1206 stores these instructions as well as other data used by processor 1204 and other modules contained in user interest analyzer 122.

User interest analyzer 122 also includes an analysis module 1208, which analyzes various words and information contained in user communications using, for example, the topic and topic cluster information discussed herein. A data management module 1210 organizes and manages data used by user interest analyzer 122 and stored in database 124. A matching and ranking module 1212 identifies topics, topic clusters, and other information that match words and other information contained in user communications. Matching and ranking module 1212 also ranks those topics, topic clusters, and other information as part of the user interest analysis process. An activity tracking module 1214 tracks click-through rate (CTR), the end conversions on a product (e.g., user actually buys a recommended product), and other similar information. CTR is the number of clicks on a particular option (e.g., product or service offering displayed to the user) divided by a normalized number of impressions (e.g., displays of options). A “conversion rate” is the actual number of conversions divided by the number of clicks.

A typical goal is to maximize CTR while keeping conversions above a particular threshold. Impression counts are normalized based on their display position. For example, an impression in the 10th position (a low position) is expected to get a lower number of clicks based on a logarithmic scale. When tracking user activity, a typical user makes several requests (e.g., communications) during a particular session. Each user request is for a module, such as a tag cloud, product, deal, interaction, and so forth. Each user request is tracked and monitored, thereby providing the ability to re-create the user session. The system is able to find the page views associated with each user session. From the click data (what options or information the user clicked on during the session), the system can determine the revenue generated during a particular session. The system also tracks repeat visits by the user across multiple sessions to calculate the lifetime value of a particular user. Additional details regarding the operation of user interest analyzer 122, and the components and modules contained within the user interest analyzer, are discussed herein.

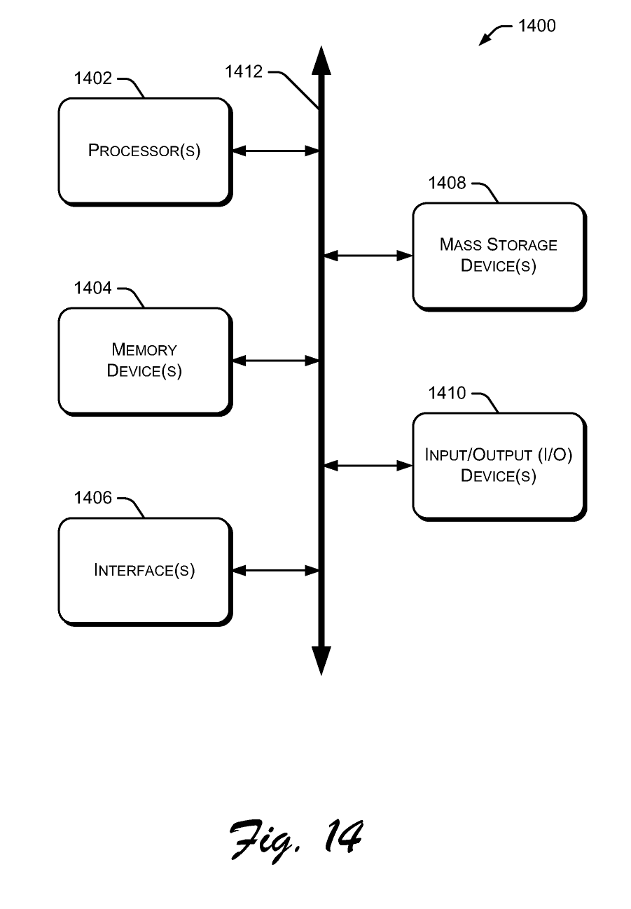

FIG. 13 is a block diagram illustrating various components of advertisement selection module 126. Advertisement selection module 126 includes a communication module 1302, a processor 1304, and a memory 1306. Communication module 1302 allows advertisement selection module 126 to communicate with other devices and services, such as the services and information sources discussed herein. Processor 1304 executes various instructions to implement the functionality provided by advertisement selection module 126. Memory 1306 stores these instructions as well as other data used by processor 1304 and other modules contained in advertisement selection module 126.

A message creator 1308 generates messages that respond to user communications and/or user interactions. Message creator 1308 uses message templates 1310 to generate various types of messages, such as advertisements or messages containing links to advertisements or other information. A tracking/analytics module 1312 tracks the messages and advertisements generated by advertisement selection module 126 to determine how well each message performed (e.g., whether the message/advertisement was appropriate for the user communication or interaction, and whether the message/advertisement was acted upon (e.g., clicked) by the user). A landing page optimizer 1314 updates the landing page to which users are directed based on user activity in response to similar communications. For example, various options presented to a user may be rearranged or re-prioritized based on previous CTRs and similar information. A response optimizer 1316 optimizes the message selected (e.g., message template or advertisement selected) and communicated to the user based on knowledge of the success rate (e.g., user takes action by clicking on a link in the response) of previous responses to similar communications.

In operation, advertisement selection module 126 retrieves social media interactions and similar communications (e.g., “tweets” on Twitter, blog posts and social media posts) during a particular time period, such as the past N hours. Advertisement selection module 126 determines a user interest score, a spam score, and so forth. Message templates 1310 include the ability to insert one or more keywords into the response, such as: {$UserName} you may want to try these {$ProductLines} from {$Manufacturer}. At run time, the appropriate values are substituted for $UserName, $ProductLines, and $Manufacturer. Response messages provided to users are tracked to see how users respond to those messages (e.g., how users respond to different versions (such as different language) of the response message or different types of advertisements).

FIG. 14 is a block diagram of a machine in the example form of a computer system 1400 within which a set of instructions, for causing the machine to perform any one or more of the methodologies discussed herein, may be executed. Computing system 1400 may be used to perform various procedures, such as those discussed herein. Computing system 1400 can function as a server, a client, or any other computing entity. Computing system 1400 can be any of a wide variety of computing devices, such as a desktop computer, a notebook computer, a tablet computer, a server computer, a handheld computer, a smart phone, and the like.

Computing system 1400 includes one or more processor(s) 1402, one or more memory device(s) 1404, one or more interface(s) 1406, one or more mass storage device(s) 1408, and one or more Input/Output (I/O) device(s) 1410, all of which are coupled to a bus 1412. Processor(s) 1402 include one or more processors or controllers that execute instructions stored in memory device(s) 1404 and/or mass storage device(s) 1408. Processor(s) 1402 may also include various types of computer-readable media, such as cache memory.

Memory device(s) 1404 include various computer-readable media, such as volatile memory (e.g., random access memory (RAM)) and/or nonvolatile memory (e.g., read-only memory (ROM)). Memory device(s) 1404 may also include rewritable ROM, such as Flash memory.

Mass storage device(s) 1408 include various computer-readable media, such as magnetic tapes, magnetic disks, optical disks, solid state memory (e.g., Flash memory), and so forth. Various drives may also be included in mass storage device(s) 1408 to enable reading from and/or writing to the various computer readable media. Mass storage device(s) 1408 include removable media and/or non-removable media.

I/O device(s) 1410 include various devices that allow data and/or other information to be input to or retrieved from computing system 1400. Example I/O device(s) 1410 include cursor control devices, keyboards, keypads, microphones, monitors or other display devices, speakers, printers, network interface cards, modems, lenses, CCDs or other image capture devices, and the like.

Interface(s) 1406 include various interfaces that allow computing system 1400 to interact with other systems, devices, or computing environments. Example interface(s) 1406 include any number of different network interfaces, such as interfaces to local area networks (LANs), wide area networks (WANs), wireless networks, and the Internet.

Bus 1412 allows processor(s) 1402, memory device(s) 1404, interface(s) 1406, mass storage device(s) 1408, and I/O device(s) 1410 to communicate with one another, as well as other devices or components coupled to bus 1412. Bus 1412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing system 1400, and are executed by processor(s) 1402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
identifying online social content associated with a plurality of users;
identifying a portion of the online social content associated with a first user; and
determining, using one or more processors, a first user interest based on the portion of the online social content associated with the first user.

2. The method of claim 1, further comprising:
determining a first user interest score associated with the first user interest, wherein the first user interest score is based on the online social content associated with the first user; and
selecting an advertisement for presentation to the first user based on the first user interest score.

3. The method of claim 2, wherein determining a first user interest score is further based on the online social content associated with a plurality of users.

4. The method of claim 2, wherein determining a first user interest score is further based on an expertise level associated with the first user.

5. The method of claim 2, wherein determining a first user interest score is further based on an online interaction level associated with the first user.

6. The method of claim 2, further comprising identifying time periods of significant online activity by the first user.

7. The method of claim 6, wherein selecting an advertisement for presentation to the first user is further based on the identified time periods of significant online activity by the first user.

8. The method of claim 1, wherein determining a first user interest further includes:
identifying a second user having a social friend relationship with the first user;
identifying a second user interest associated with the second user; and
associating the second user interest with the first user.

9. The method of claim 1, further comprising inferring a second user interest based on the first user interest.

10. The method of claim 1, wherein online social content includes online social interactions.

11. The method of claim 1, wherein online social content includes social media communications.

12. The method of claim 1, wherein online social content includes user profile data associated with a social media web site.

13. The method of claim 1, wherein online social content includes an activity associated with an online following of another user.

14. The method of claim 1, wherein determining a first user interest includes analyzing a set of n-grams associated with topics in the online social content associated with a plurality of users.

15. The method of claim 1, wherein determining a first user interest includes analyzing a connected graph associated with topics in the online social content associated with a plurality of users.

16. The method of claim 15, wherein the connected graph includes a plurality of nodes, each of the plurality of nodes associated with a word contained in the online social content associated with a plurality of users.

17. A non-transitory machine-readable storage medium comprising instructions that, when executed by one or more processors of a machine, cause the machine to perform operations comprising:
identifying online social content associated with a plurality of users;
identifying a portion of the online social content associated with a first user;
determining a plurality of topics associated with the portion of the online social content associated with the first user; and
determining a topic of likely interest to the first user based on the topics associated with the portion of the online social content associated with the first user.

18. The non-transitory machine-readable storage medium of claim 17, the machine to further select an advertisement for presentation to the first user based on the topic of likely interest to the first user.

19. An apparatus comprising:
a communication module configured to identify online social content associated with a plurality of users;
an analysis module configured to identify a portion of the online social content associated with a first user, the analysis module further configured to determine a first user interest based on the portion of the online social content associated with the first user; and
an advertisement selection module configured to select an advertisement for presentation to the first user based on the first user interest.

20. The apparatus of claim 19, further comprising a topic extraction module configured to identify at least one topic in the online social content associated with a plurality of users.
